(19) United States
(12) Patent Application Publication
(10) Pub. No.: US 2026/0115599 A1
(43) Pub. Date: Apr. 30, 2026

(54) NARRATIVE SPACE GENERATION FOR AI-BRIDGED INTERACTIVE STORYTELLING

(71) Applicant: AUTODESK, INC., San Francisco, CA (US)

(72) Inventors: Yi WANG, Richmond, CA (US); Zhuoran LU, West Lafayette, IN (US); Qian ZHOU, San Francisco, CA (US)

(21) Appl. No.: 19/239,820

(22) Filed: Jun. 16, 2025

Related U.S. Application Data
(60) Provisional application No. 63/713,550, filed on Oct. 29, 2024.

(51) Int. Cl. A63F 13/65

(52) U.S. Cl. CPC A63F 13/65

(57) ABSTRACT

A computer-implemented method includes receiving a text-based story; generating, via a generative artificial intelligence (AI) model, a narrative outline based on the text-based story; generating one or more narrative instances based on the narrative outline; simulating a performance of each of the one or more narrative instances; and displaying, via at least one user interface, a visual representation of the performance of each of the one or more narrative instances.

### CROSS-REFERENCE TO RELATED APPLICATIONS

This application claims priority benefit of the United States Provisional Patent Application titled, “TECHNIQUES FOR AUTHORING NARRATIVE SPACES FOR AI-BRIDGED INTERACTIVE STORYTELLING,” filed on Oct. 29, 2024 and having Ser. No. 63/713,550. The subject matter of this related application is hereby incorporated herein by reference.

### FIELD OF THE VARIOUS EMBODIMENTS

The various embodiments relate generally to computer science and complex software applications, and, more specifically, to narrative space generation for artificial intelligence (AI) bridged interactive storytelling.

### DESCRIPTION OF THE RELATED ART

In modern computerized role-playing games, interactive narrative represents an essential game element that facilitates a gaming experience based on specific player choices. An interactive narrative consists of numerous potential story branches, forming what is commonly referred to as a narrative space, which includes all possible storylines a player can experience.

Traditionally, the author of an interactive narrative manually creates every possible narrative instance in the interactive narrative. For example, to enable the execution of manually written plots and to generate a sequence of state transitions, such as game events that guide a gaming world state to a narrative goal of an author, the author explicitly models a story domain and simulates the causal dynamics of all possible plot events through symbolic narrative planning. However, symbolic narrative planning generally requires extensive knowledge of the preconditions and effects of each predefined action set within a story and the use of formal logical language that defines each precondition and effect. Given the extensive engineering work required to construct a narrative space in this manner, the generated plots offer limited complexity and scale.

Artificial intelligence (AI) technologies are now transforming this paradigm. Instead of drafting every possible narrative instance for each player character within a narrative space, authors can provide abstract specifications to an AI-based system or model capable of dynamically generating game content at playtime. The application of AI in this manner indicates that a narrative space for a particular game is no longer manually authored but is co-created by one or more human authors and an AI-based model.

One drawback of AI-generated interactive narratives is that a human co-author cannot readily perceive the boundaries of the narrative space of conceivable plot events a player might experience. Because an AI-based model generates most or all of the narrative instances encountered by a player at playtime, a human co-author cannot determine and eliminate plot events that are possible but incompatible with the intent of the human co-author. For example, a series of playtime-generated narrative instances encountered by a player might diverge from an overall narrative structure intended by the human co-author, or an intended moral of an interactive narrative might be undermined by plotlines generated at playtime by the AI-based model. Owing to the large number of narrative instances typical of interactive narratives, a human co-author cannot comprehensively review the plotlines that might be generated at playtime by the AI-based model without extensive and time-consuming playtesting, potentially through numerous iterations of player simulations. Consequently, a player experience might diverge significantly from what the human co-author envisioned.

Another drawback of AI-generated interactive narratives is that a human co-author cannot easily control the boundaries of the narrative space. Generally, the human co-author provides abstract specifications or prompts to the AI-based model to control which narrative instances might be generated at playtime, yet receives little or no feedback regarding the interactive narratives the AI-based model might generate at playtime. If the co-author defines the narrative space with overly detailed or specific prompts, the narrative space might become too small, with narrative instances generated at playtime being too similar to each other. Conversely, if the co-author defines the narrative space with overly abstract prompts, the narrative space might become too broad, and the narrative instances generated at playtime might diverge significantly from the narrative intent of the human co-author.

As the foregoing illustrates, what is needed in the art are more effective techniques for authoring interactive narratives in conjunction with AI.

### SUMMARY

A computer-implemented method for generating narrative spaces for interactive storytelling includes: receiving a text-based story; generating, via a generative artificial intelligence (AI) model, a narrative outline based on the text-based story; generating one or more narrative instances based on the narrative outline; simulating a performance of each of the one or more narrative instances; and displaying, via at least one user interface, a visual representation of the performance of each of the one or more narrative instances.

At least one technical advantage of the disclosed techniques relative to the prior art is that the disclosed techniques enable boundaries of a narrative space of an interactive narrative to be clearly perceived. Without relying on extensive play testing, the techniques permit detection and elimination of narrative instances that diverge from the intended narrative. Furthermore, the boundaries of the narrative space can be controlled by directly configuring the level of abstraction of words or sentences in the outline that defines the narrative space. Consequently, narrative instances generated at play time can maintain diversity without diverging excessively from the intended narrative. Additionally, by facilitating clearer perception and control of the narrative boundaries, the disclosed techniques enhance narrative precision and consistency while reducing development time and resources. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 conceptually illustrates a narrative planning system, according to various embodiments.

FIG. 2 conceptually illustrates a pivot plot view of a representative narrative instance of a story provided by a human co-author, according to various embodiments.

FIG. 3 conceptually illustrates an outline view of a narrative outline for a narrative space, according to various embodiments.

FIG. 4 conceptually illustrates a narrative space that is based on the narrative outline of FIG. 3, according to various embodiments.

FIG. 5 conceptually illustrates an abstraction tool tip for modifying a narrative outline for a narrative space, according to various embodiments.

FIG. 6 conceptually illustrates a variant view of a narrative space, according to various embodiments.

FIG. 7 conceptually illustrates a narrative space that has an expanded boundary, according to various embodiments.

FIG. 8 conceptually illustrates an abstraction ladder for modifying a narrative outline for narrative space, according to various embodiments.

FIG. 9 conceptually illustrates a narrative space that has a contracted boundary due to removal of a narrative instance from the narrative space, according to various embodiments.

FIG. 10 sets forth a flowchart of method steps for generating narrative spaces for interactive storytelling, according to various embodiments.

FIG. 11 is a block diagram of a computing device configured to implement one or more aspects of the various embodiments.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### System Overview

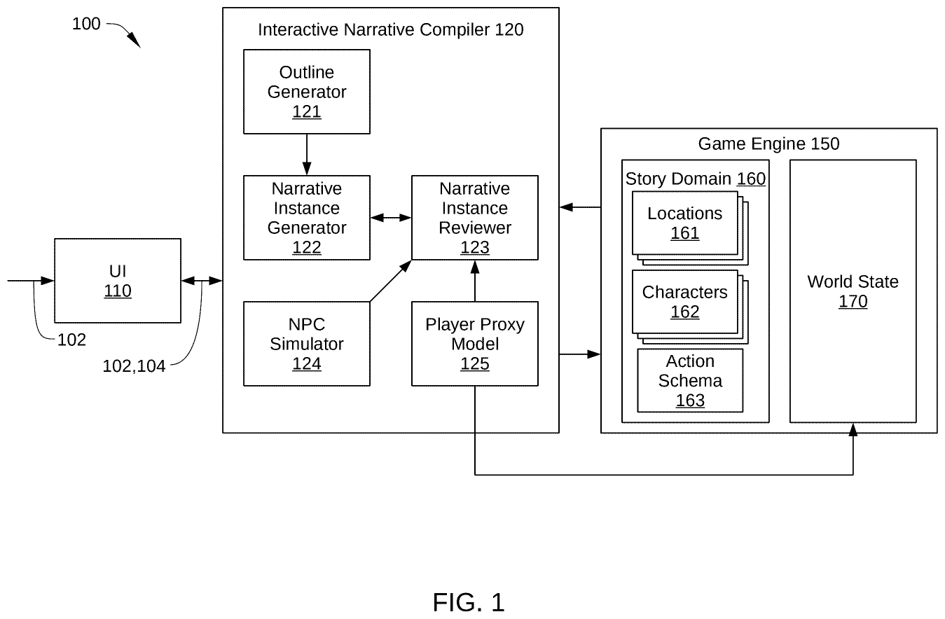

FIG. 1 conceptually illustrates a narrative planning system 100, according to various embodiments. Narrative planning system 100 is an artificial intelligence (AI) based system configured for authoring a narrative space from one or more example stories, where the narrative space generally includes a plurality of possible interactive narratives. Narrative planning system 100 enables a human co-author to understand and modify the boundaries of the narrative space with linguistic abstraction tools that control the boundaries of the narrative space. For example, the narrative space can be employed in a game that includes interactive storytelling, in which specific narrative instances are experienced by a player at play time based on previous actions of the player. Thus, for such a game, narrative planning system 100 enables a human co-author to generate a narrative space that includes engaging interactive narratives that also do not diverge too far from the narrative intent of the human co-author when generated at play time. In the embodiment illustrated in FIG. 1, narrative planning system 100 includes a user interface (UI) 110, an interactive narrative compiler 120, and a game engine 150.

Interactive narrative compiler 120 generates an interactive narrative, referred to herein as a narrative space, from one or more user-provided example narrative instances, such as a text-based story or narrative that is uploaded to narrative planning system 100 as an input 102. More specifically, interactive narrative compiler 120 uses a large-language model (LLM) to generate an outline that defines the boundaries of the narrative space based on one or more narrative instances. In addition, interactive narrative compiler 120 uses an LLM to generate one or more concrete narrative instances based on the outline for the narrative space. Thus, interactive narrative compiler 120 to act as a technical pipeline that supports bidirectional transformation between narrative space outlines and narrative instances using LLMs. Further, interactive narrative compiler 120 enables a human co-author to shape the narrative space by changing a level of abstraction of the narrative space outline and/or language included in one or more narrative instances. In the embodiment illustrated in FIG. 1, interactive narrative compiler 120 includes an outline generator 121, a narrative instance generator 122, a narrative instance reviewer 123, a non-player character (NPC) simulator 124, and a player proxy model 125.

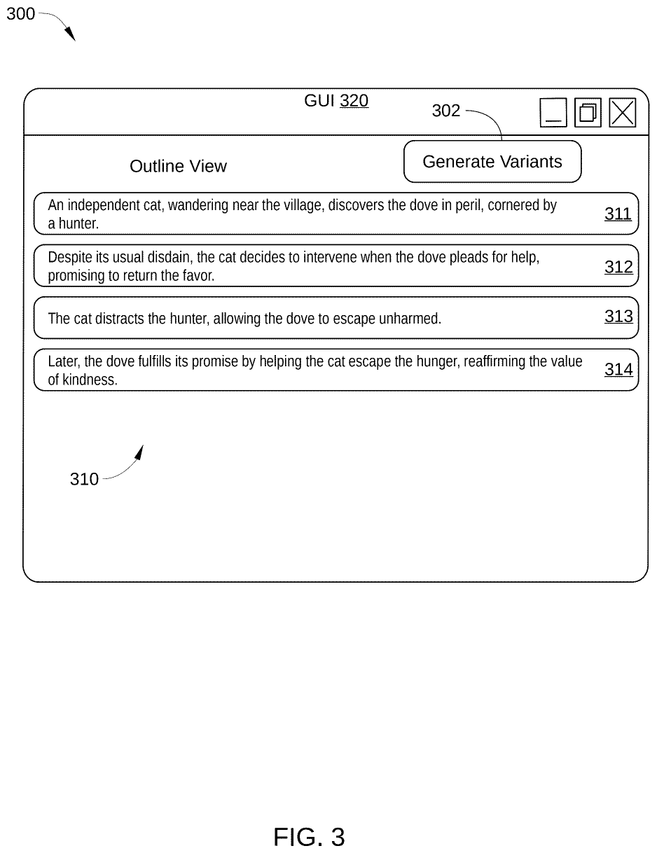

Outline generator 121 generates a narrative outline for a narrative space by abstracting from one or more narrative instances, such as a text-based story uploaded to interactive narrative compiler 120, a narrative instance generated previously by narrative instance generator 122, and/or a narrative instance that has been modified by the human co-author to have a different level of abstractness. An example embodiment of a narrative outline is described below in conjunction with FIG. 3.

In some embodiments, outline generator 121 includes an LLM that extracts a series of events from the text-based story or other narrative instance. Based on the extracted series of events, the LLM of outline generator 121 generates a narrative outline by abstracting the series of events and summarizing actions of characters included in the series of events. Thus, instead of a human co-author writing abstract prompts to generate a narrative space with an LLM, such embodiments enable a human co-author to generate a narrative space by importing a narrative instance as a pivot plot. Alternatively, or additionally, in some embodiments, the LLM of outline generator 121 generates a narrative outline by capturing the commonality across multiple narrative instances currently included in the narrative space. For example, in such embodiments, outline generator 121 can generate such a narrative outline in response to one or more narrative instances being modified or deleted from the narrative space. In such embodiments, the narrative outline represents the most abstract manifestation of the narrative intent of the human co-author, and thus defines a new boundary of the narrative space.

In some embodiments, outline generator 121 includes an LLM prompting pipeline to generate one or more narrative outlines based on multiple narrative instances. In such embodiments, the pipeline first prompts the LLM with domain knowledge in drama writing, context of the story domain or genre, and the multiple narrative instances. The pipeline then prompts the LLM to summarize the commonalities across these narrative instances, generating one or more narrative outlines. In some embodiments, outline generator 121 generates one narrative outlines for each of multiple different abstraction levels. In such embodiments, the human co-author can then select a narrative outline that reflects a desired level of abstraction.

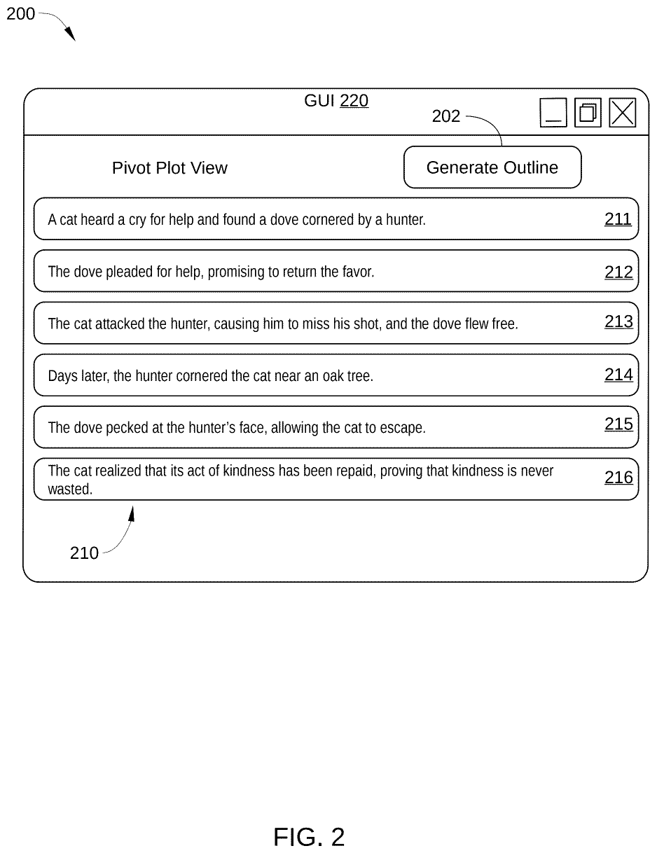

Narrative instance generator 122 generates one or more narrative instances from a narrative outline included in a narrative space using an LLM-based narrative planning method. Each generated narrative instance can be experienced by a player as an alternative or additional narrative plot at play time of an interactive narrative game. An example embodiment of a narrative instance is described below in conjunction with FIG. 2.

In some embodiments, for each event in the narrative outline, narrative instance generator 122 generates a sequence of character actions that acts out the event. In such embodiments, during game play, characters take selectable actions between the events, where the actions of a player character are determined by a player input and the actions of an NPC are driven by an LLM. Generally, the generated narrative instances are grounded by character action sequences executable in the game environment and limited by such game-associated factors as world state (e.g., which characters are alive, where each character is located, etc.) and story domain information (e.g., locations 161, characters 162, and action schema 163).

Narrative instance reviewer 123 enables a human co-author to review the performance of some or all narrative instances generated by narrative instance generator 122. For example, in some embodiments, narrative instance reviewer 123 quantifies the performance of a particular narrative instance by simulating the behavior of a player character in the intended game environment, which is enabled by NPC simulator 124, player proxy model 125, and game engine 150. In the simulation of player character behavior, a particular character takes different actions as the events of the narrative instance progress from start to end, thereby producing an emergent narrative that develops based on the actions of the character. In such simulations, the actions of NPC characters in-game are driven by an LLM (e.g., NPC simulator 124), while player character behavior is simulated by player proxy model 125. Narrative instance reviewer 123 then determines the performance of the emergent narrative using one or more quantifiable performance metrics. For example, in some embodiments, the performance of each simulated emergent narrative is quantified using an emergence distance and/or an authorial intent distance.

In some embodiments, emergence distance quantifies an amount by which a sequence of events or plot progression that occurs in the emergent narrative diverges from the intended authorial plot sequence (e.g., a pivot plot of the narrative space). In such embodiments, narrative instance reviewer 123 calls or prompts a suitable LLM to calculate the narrative distance between a representative narrative instance, such as the pivot plot for the narrative space, and the simulated emergent narrative. In some embodiments, the emergence distance is normalized to vary from 0.0 to 1.0, where a simulated emergent narrative that closely follows the pivot plot has a value that approaches 1.

In some embodiments, authorial intent distance quantifies an amount by which a moral expressed by the narrative instance differs from the moral of the pivot plot of the narrative space. In such embodiments, narrative instance reviewer 123 calls or prompts a suitable LLM to determine a moral of the simulated emergent narrative and compare that to a moral of the pivot plot. In some embodiments, the moral of the pivot plot is a stated moral that is uploaded as an input 102 to narrative planning system 100. In other embodiments, the moral of the pivot plot is determined by the LLM. In either case, the LLM then calculates a textual distance between the two morals. In some embodiments, the authorial intent distance is normalized to vary from 0.0 to 1.0, where a simulated emergent narrative that has a similar moral to the pivot plot has a value that approaches 1.

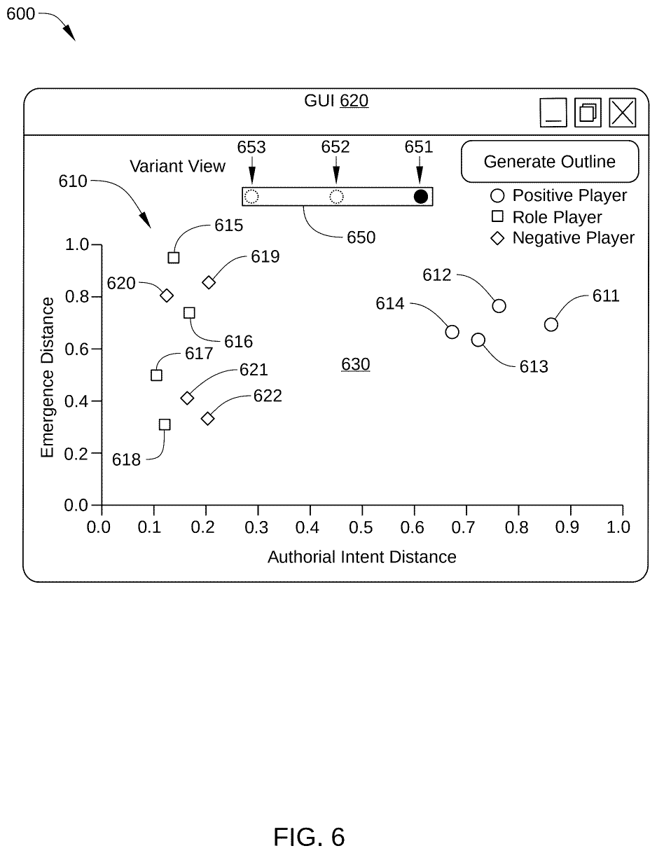

In some embodiments, instance reviewer 123 plots the performance of some or all narrative instances generated by narrative instance generator 122, for example via a variant view of the narrative space. In such a variant view, the human co-author can quickly determine narrative instances that diverge significantly from the authorial narrative intent, and remove such narrative instances from the narrative space. An example embodiment of a variant view of a narrative space is described below in conjunction with FIG. 6.

In some embodiments, narrative instance reviewer 123 simulates an emergent narrative using different player character behaviors. For example, in some embodiments, available player character types include positive players, negative players, and role players. In such embodiments, positive players tend to contribute positively by following the intended game objectives and exhibiting helping behaviors, negative players tend to exhibit aggressive behavior that disrupts the experience of others, particularly when seeking to dominate or harm others, and role players tend to prioritize narrative immersion and character development by mimicking the actions their character would take in the gaming world. In such embodiments, a narrative instance can be simulated with each different player proxy model 125. In this way, a diverse set of potential plots that can emerge within the narrative space can be generated from the interaction between game characters and simulated players.

Game engine 150 provides a game environment for the simulation of emergent narratives. In the embodiment illustrated in FIG. 1, game engine 150 includes a story domain 160 and a world state 170. Story domain 160 includes the elements of the game environment, such as locations 161 and associated information, characters 162 and associated information, and an action schema, which provides the possible actions (and consequences thereof) available to the characters 162. World state 170 records the current some status of each of the characters 162 and locations 161. Generally, world state 170 can be modified in response actions taken by characters 162 as one or more narrative instances progress.

UI 110 enables a user to provide inputs 102 to and view or otherwise receive outputs 104 from narrative planning system 100, for example via suitable input/output (I/O) devices. For example, in some embodiments, UI 110 includes a graphical user interface (GUI) that is displayed via a suitable display device. Alternatively, or additionally, in some embodiments, UI 110 includes a command-line interface that enables a user to interact with transient atmosphere generation system 100 via typed commands and text-based output. In some embodiments, the command-line interface can be a terminal window or other text-based window within a GUI. Thus, in some embodiments, inputs 102 and/or outputs 104 can be graphical and/or text-based.

In some embodiments, UI 110 can be implemented as a virtual reality (VR) and/or augmented reality (AR) interface. In such embodiments, UI 110 can include a head-mounted display (not shown) for rendering a VR or AR environment for a user of transient atmosphere generation system 100. In some embodiments, the head-mounted display of UI 110 is employed by a user in conjunction with one or more interaction devices (not shown), which are devices configured to enable a user to interact with portions of the VR or AR environment generated by UI 110. For example, in some embodiments, such interaction devices include a wired glove that is worn by the user. In embodiments in which UI 110 is implemented as a VR and/or AR interface, a designer can be more fully immersed in the transient vibe constructed for a particular space or environment.

Inputs 102 can include a text-based story, such as a story intended by a human co-author or other user of narrative planning system 100 to be a representative narrative instance included in a narrative space. Inputs 102 can further include user inputs for reviewing and/or modifying a narrative space, for example by editing the text of a narrative instance or outline associated with the narrative space, deleting a narrative instance included in a narrative space, requesting generation of an outline for the narrative space, and/or changing an abstraction level of a word or sentence included in an outline for the narrative space.

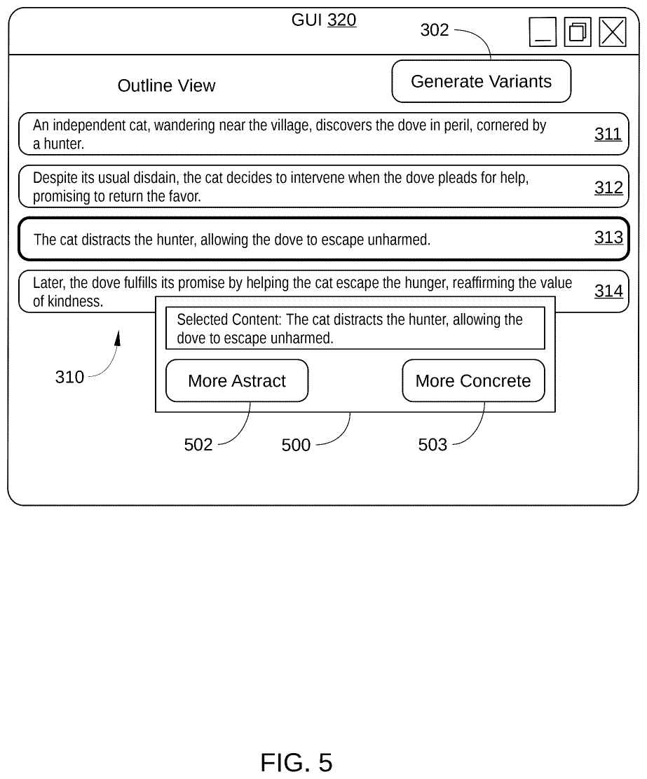

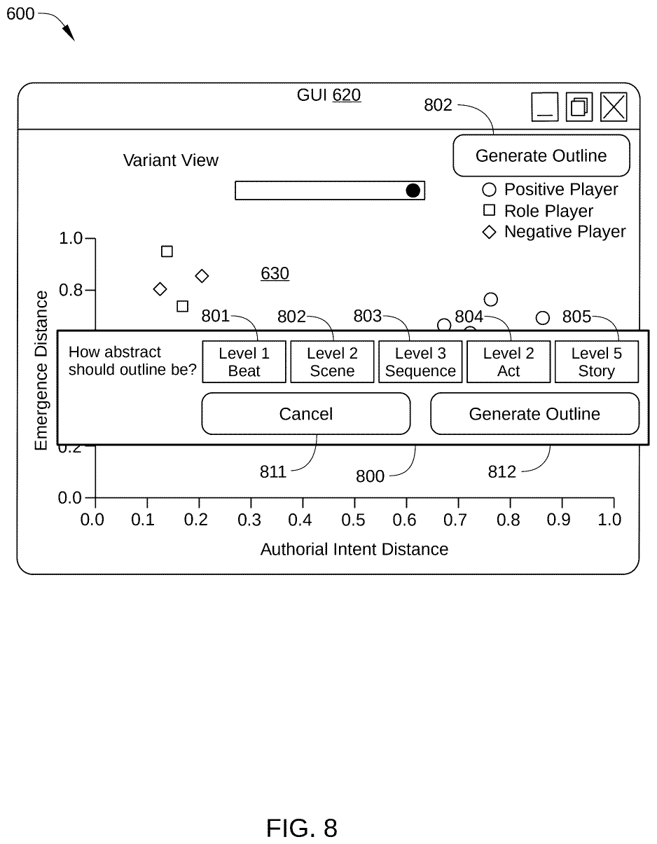

Outputs 104 can include one or more views, tools, and/or interfaces for controlling the boundaries of the narrative space via interactive narrative compiler 120. Examples of such views, tools, and/or interfaces include a plot view for reviewing and editing a sequence of events extracted from an uploaded story and an outline view for reviewing and editing an outline of events for the narrative space. In some embodiments, outputs 104 also include one or more linguistic abstraction tools, such as an abstraction ladder for generation of a suitably abstract story outline and an abstraction tool for changing the level of abstraction of a word or sentence in a story outline. In some embodiments, outputs 104 also include a variant view for displaying the quantified performance of some or all narrative instances included in the narrative space. Outputs 104 can further include one or more game-related views or interfaces that are generated by game engine 150, for example as part of play testing performed by the human co-author in order to experience one or more narrative instances in-game. Embodiments of a plot view are described below in conjunction with FIG. 2, embodiments of an outline view are described below in conjunction with FIG. 3, embodiments of an abstraction tool tip are described below in conjunction with FIG. 5, embodiments of a variant view are described below in conjunction with FIG. 6, and embodiments of an abstraction ladder are described below in conjunction with FIG. 8.

### User Interfaces for Interactive Narrative Space Generation

FIG. 2 conceptually illustrates a pivot plot view 200 of a representative narrative instance 210 of a story provided by a human co-author, according to various embodiments. In the embodiment illustrated in FIG. 2, pivot plot view 200 is displayed via a graphical user interface (GUI) 220 that is rendered by UI 110 of FIG. 1.

Pivot plot view 200 is displayed to a user, such as a human co-author, to enable the user to review and/or edit representative narrative instance 210. According to various embodiments, representative narrative instance 210 is employed by narrative planning system 100 as a pivot plot from which a plurality of variant narrative instances (not shown in FIG. 2) are generated, where each variant narrative instance can be experienced by a player as an alternative or additional narrative plot at play time. Together, the pivot plot and the variant narrative instances form a narrative space that includes all the possible story lines a player can experience.

In some embodiments, pivot plot view 200 shows representative narrative instance 210 as a series of events 211-216. When a text-based story is uploaded to interactive narrative compiler 120 as an input 102 (as shown in FIG. 1), events 211-216 are extracted from the text-based story, for example via a large language model (LLM) associated with interactive narrative compiler 120. Events 211-216 progress sequentially in a linear fashion. Thus, in the embodiment illustrated in FIG. 2, event 211 is the first event to occur in the text-based story and event 216 is the last event to occur in the text-based story. Events 211-216 are used by interactive narrative compiler 120 to generate one or more outlines for the text-based story. For example, in some embodiments, user selection of a Generate Outline button 202 included in pivot plot view 200 causes outline generator 121 of FIG. 1 to generate a narrative outline for defining a narrative space based on events 211-216 from the text-based story.

FIG. 3 conceptually illustrates an outline view 300 of a narrative outline 310 for a narrative space, according to various embodiments. Outline view 300 is displayed to a user, such as a human co-author, to enable the user to review and/or edit narrative outline 310, where narrative outline 310 is an abstract narrative specification defining a narrative space. In the embodiment illustrated in FIG. 3, plot view 300 is displayed via a GUI 320 that is rendered by UI 110 of FIG. 1.

Narrative outline 310 is based on representative narrative instance 210 in FIG. 2. Thus, in some embodiments, outline generator 121 of FIG. 1 generates narrative outline 310 by abstracting events 211-216 of representative narrative instance 210 and summarizing actions of characters included in events 211-216. For example, in the embodiment illustrated in FIG. 3, narrative outline 310 includes a series of high-level events 311-314 that are based on events 211-216, where high-level event 311 is a broad description of event 211, high-level event 312 is a broad description of event 212, high-level event 313 is a broad description of event 213, and high-level event 314 is a broad description of events 214-216 as a single event.

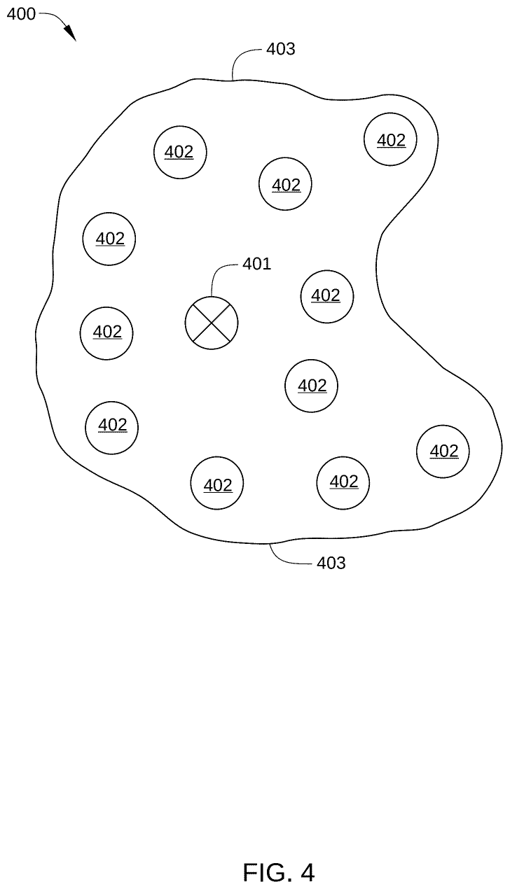

According to various embodiments, high-level events 311-314 define the boundaries of the narrative space, and represent the most abstract manifestation of the narrative intent of the human co-author. Consequently, additional narrative instances generated by narrative planning system 100, as described herein, also fall within the boundary of the narrative space defined by narrative outline 310. For example, in some embodiments, user selection of a Generate Variants button 302 included in outline view 300 causes narrative instance generator 122 of FIG. 1 to generate one or more variant narrative instances based on narrative outline 310. One embodiment of the narrative space that is based on narrative outline 310 is described below in conjunction with FIG. 4.

FIG. 4 conceptually illustrates a narrative space 400 that is based on narrative outline 310, according to various embodiments. Narrative space 400 is an abstract representation of all the possible story lines associated with a narrative outline that a player can experience at play time, where the narrative outline is based on the uploaded text-based story. As shown, narrative space 400 includes a pivot plot 401, a plurality of variant narrative instances 402, and a narrative boundary 403. In addition, pivot plot 401 and variant narrative instances 402 are disposed within boundary 403.

Pivot plot 401 is considered the representative narrative instance for narrative space 400, and is a user-provided and/or user-edited narrative instance that can occur within the game that includes narrative space 400. For example, in some embodiments, pivot plot 401 is consistent with narrative instance 210 in FIG. 2, which is based on a text-based story uploaded as an input 102 to narrative planning system 100 for use in an interactive narrative game. Variant narrative instances 402 are variants of pivot plot 401 that are generated by narrative instance generator 122 of FIG. 1. Boundary 403 abstractly depicts the limit of possible narrative experiences of a player at play time and actions of non-play characters (NPCs) in the game that includes narrative space 400.

FIG. 5 conceptually illustrates an abstraction tool tip 500 for modifying a narrative outline for a narrative space, according to various embodiments. Abstraction tool tip 500 is displayed to a user, such as a human co-author, to enable the user to review and/or edit a narrative outline, such as narrative outline 310. In the embodiment illustrated in FIG. 5, abstraction tool tip 500 is displayed via GUI 320, for example when abstraction tool type 500 is activated.

Abstraction tool tip 500 is a linguistic abstraction tool that enables a human co-author to request that a specific portion of narrative outline 310 be made more or less abstract, thereby modifying the linguistic boundaries of the narrative space that is based on narrative outline 310. In the embodiment illustrated in FIG. 5, abstraction tool tip 500 is activated by selecting an individual word, a phrase, or a complete high-level event (e.g., one of high-level events 311-314) included in narrative outline 310. As shown, when activated, abstraction tool tip 500 provides the ability to make selected text 510 either more concrete with a More Concrete button 501 or more abstract with a More Abstract button 502. Therefore, abstraction tool tip 500 enables the human co-author to directly adjust the abstraction level of individual elements in narrative outline 310 in a highly granular fashion, for example at the word level or the phrase level.

In some embodiments, abstraction tool tip 500 shows the selected content in a Selected Content window 503. Alternatively, or additionally, in some embodiments, abstraction tool tip 500 shows one or more suggestions for replacing the selected content. In some embodiments, the one or more suggestions are based on a linguistic hierarchy that includes one or more words of the selected content. For example, a linguistic hierarchy of descending arbitrariness can be: “character“−“animal“−“small animal“−“cat“−“tabby cat.” Thus, given a selected text snippet “cat”, requesting a more abstract suggestion would yield the superordinate term “small animal” or “animal,” while requesting a more concrete suggestion would yield the subordinate term “tabby cat.”

FIG. 6 conceptually illustrates a variant view 600 of a narrative space 630, according to various embodiments. Variant view 600 is displayed to a user, such as a human co-author, to enable the user to review the relative performance of, edit, and/or delete specific narrative instances 610 included in narrative space 610. In the embodiment illustrated in FIG. 6, variant view 600 is displayed via a GUI 620 that is rendered by UI 110 of FIG. 1.

In variant view 600, narrative space 630 is depicted as a plurality of narrative instances 611-622 (referred to collectively herein as “variant narrative instances 610”) that are each represented as a point on a graph. Each point represents the simulated performance of one particular variant narrative instance 610 when experienced by a simulated player of an interactive narrative game that is based on narrative space 630. In the embodiment of variant view 600 illustrated in FIG. 6, the performance of each variant narrative instance 610 is quantified with respect to an Emergence Distance and an Authorial Intent Distance. In other embodiments, the performance of each variant narrative instance 610 with respect to any other quantifiable performance metric can be included in variant view 600. Alternatively, or additionally, in some embodiments, the performance of each variant narrative instance 610 is displayed with respect to a single performance metric, and in other embodiments, the performance of each variant narrative instance 610 is displayed with respect to a three performance metrics, for example in a three-dimensional plot.

In FIG. 6, Emergence Distance quantifies an amount by which a sequence of events or a plot progression that occurs in a simulated emergent narrative for a particular narrative instance 610 diverges from the intended authorial plot sequence, such as that included in a pivot plot of the narrative space. Authorial Intent Distance quantifies an amount by which a moral expressed by the particular narrative instance differs from the moral of the pivot plot of the narrative space.

In some embodiments, each narrative instance can be simulated with a different player proxy model 125, e.g., a positive player, a negative player, and a role player. In such embodiments, each separate simulation is represented by a different narrative instance 610 in variant view 600. As a result, a diverse set of possible emergent narratives that can occur within narrative space 630 can be presented to the human co-author.

In some embodiments, a value for Emergence Distance and for Authorial Intent Distance can be determined and displayed for each variant narrative instance 610 at multiple points in the narrative progression. Thus, in such embodiments, Emergence Distance and for Authorial Intent Distance can be provided to the human co-author at, for example the beginning, the midpoint, and the end of the narrative instance. In such embodiments, variant view 600 includes a narrative progression slider 650 or other selectable indicator for selecting a point in the narrative progression to display the values for Emergence Distance and Authorial Intent Distance. In the embodiment illustrated in FIG. 6, narrative progression slider 650 is set to an end point 651 of the narrative progression. Consequently, the Emergence Distance and Authorial Intent Distance shown for each of narrative instances 610 corresponds to the Emergence Distance and Authorial Intent Distance that is determined for that narrative instance at the end the narrative instance 610, for example when the last event of each narrative instance has occurred. By contrast, when narrative progression slider 650 is set to a mid point 652 of the narrative progression, the Emergence Distance and Authorial Intent Distance shown for each of narrative instances 610 corresponds to the Emergence Distance and Authorial Intent Distance that is determined for that narrative instance at a mid point of the narrative instance 610. Further, when narrative progression slider 650 is set to beginning point 653 of the narrative progression, the Emergence Distance and Authorial Intent Distance shown for each of narrative instances 610 corresponds to the Emergence Distance and Authorial Intent Distance that is determined for that narrative instance near the beginning of the narrative instance 610, for example after a specified number of actions have been taken by a simulated character.

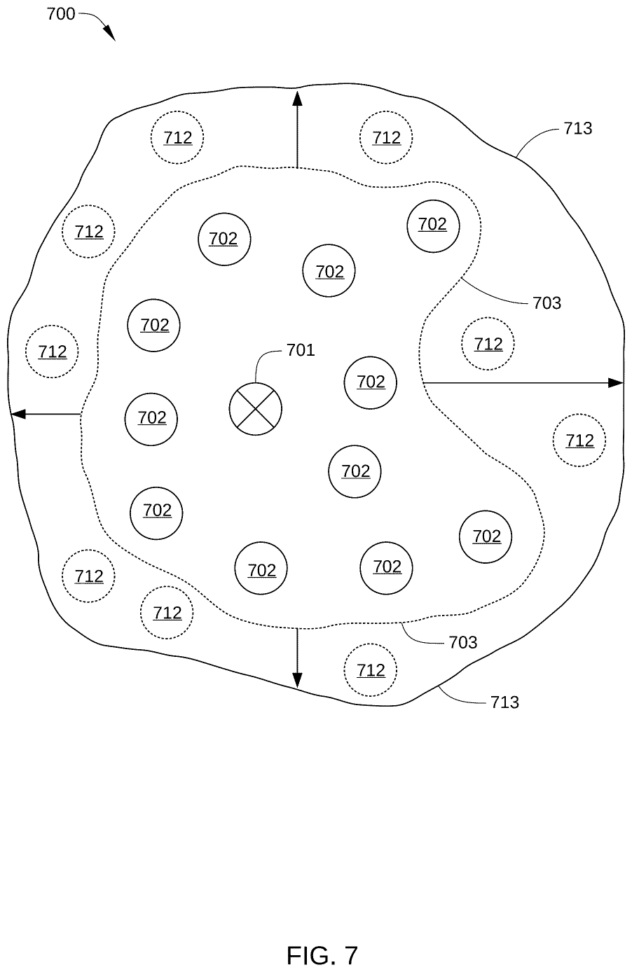

Variant view 600 enables a human co-author to determine whether to constrain or relax the boundary of narrative space 630. For example, when too many narrative instances 610 are indicated to perform poorly in variant view 600, the human co-author can adjust the level of abstraction of the narrative outline of narrative space 630. Generally, the more abstract the language included in a narrative outline is, the less constrained the associated narrative space is. By making an event description “the ant fell into water” more abstract, for example by changing the description to “a small creature got into an accident,” more possible narrative instances can be generated by narrative instance generator 122, since the constraint on the small creature being the ant is removed, and the constraint on the accident being falling into water is removed. Consequently, a less constrained narrative space allows stronger player agency, but results in looser authorial structure. One embodiment of narrative space 630 that is modified in this way is described below in conjunction with FIG. 7.

FIG. 7 conceptually illustrates a narrative space 700 that has an expanded boundary, according to various embodiments. Consistent with narrative space 400 in FIG. 4, narrative space 700 is an abstract representation of all the possible story lines associated with a narrative outline that a player can experience at play time, where the narrative outline is based on a representative narrative instance, such as an uploaded text-based story. As shown, narrative space 700 includes a pivot plot 701, a plurality of original narrative instances 702, an original narrative boundary 703, and an expanded narrative boundary 713. Pivot plot 701 is a representative narrative instance for narrative space 700 and original narrative instances 702 are narrative instances that are generated based on an original narrative outline that is conceptually depicted as original narrative boundary 703. Expanded narrative boundary 713 corresponds to the less constrained narrative space that results when the narrative outline defining narrative space 700 is modified to include more abstract language. Further, because the boundary of narrative space 700 is expanded from initial narrative boundary 703 to expanded narrative boundary 713, additional narrative instances 712 can be generated for narrative space 700.

In the embodiment illustrated in FIG. 7, initial narrative boundary 703 can be to expanded narrative boundary 713 by increasing the abstraction level of the narrative outline associated with narrative space 700. In some embodiments, narrative planning system 100 provides a human co-author with a linguistic abstraction tool to increase the abstraction level of a narrative outline. One example of such a linguistic abstraction tool is abstraction tool tip 500 in FIG. 5. Another example of such a linguistic abstraction tool is an abstraction ladder. One embodiment of an abstraction ladder is described below in conjunction with FIG. 8.

FIG. 8 conceptually illustrates an abstraction ladder 800 for modifying a narrative outline for narrative space 630, according to various embodiments. Abstraction ladder 800 is displayed to a user, such as a human co-author, to enable the user to generate a modified narrative outline. In the embodiment illustrated in FIG. 8, abstraction ladder 800 is displayed via GUI 620, for example when abstraction tool type 800 is activated by a Generate Outline button 802 included in GUI 620. In other embodiments, abstraction ladder 800 can be activated from a pivot plot view, such as pivot plot view 200 in FIG. 2, or whenever a human co-author requests narrative planning system 100 to generate a narrative outline.

Abstraction ladder 800 is a linguistic abstraction tool that enables a human co-author to change the level of abstraction of a narrative outline. For example, in the embodiment illustrated in FIG. 8, abstraction ladder 800 includes five selectable abstraction levels 801-805. In the embodiment illustrated in FIG. 8, abstraction ladder 800 further includes a cancel button 811 for canceling the action of generating a new narrative outline and a generate outline button 812 for implementing the generation of the new outline at the selected abstraction level.

A narrative outline generated at the lowest level of abstraction (in this case abstraction level 801, which is labeled a “beat” level of abstraction) is similar in specificity to a specific narrative instance, while an outline at the highest level of abstraction (in this case abstraction level 805, which is labeled a “story” level of abstraction) summarizes the plot into a one-line overview. Between abstraction level 801 and abstraction level 805, each level of abstraction is progressively more abstract than the previous abstraction level. For instance, at abstraction level 802 (which is labeled a “scene” level of abstraction), a narrative outline provides detailed descriptions of specific scenes, including characters, actions, etc., such as: “The kind dove takes a leaf to reach the ant and drags it out of a water bubble.” On the other hand, at abstraction level 804 (which is labeled a “acts” level of abstraction), a narrative outline offers a highly summarized view of the narrative space, focusing on the turning points: “A character saves their friend from danger.” Therefore, abstraction ladder 800 enables the human co-author to directly adjust the abstraction level of a narrative outline, thereby expanding or contracting the boundary of the narrative space.

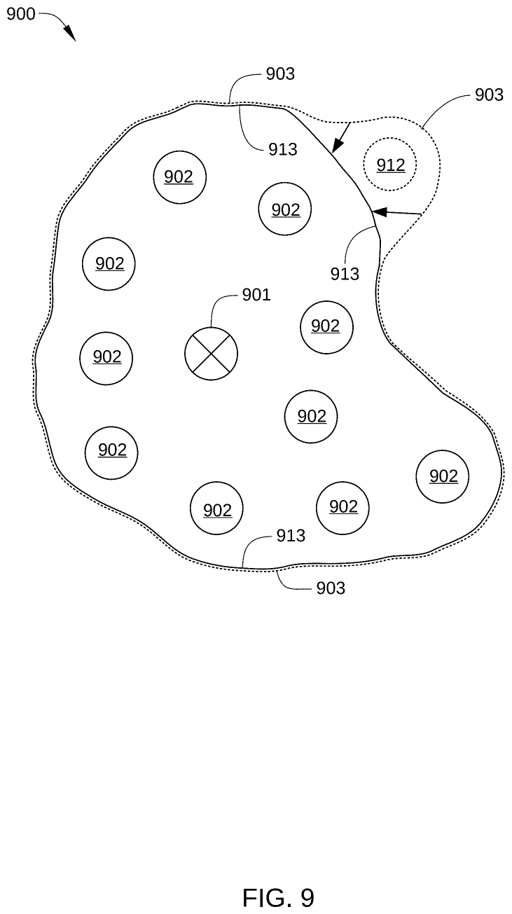

As described above, in some embodiments, the boundary of the narrative space can be expanded or contracted by modifying the narrative outline for the narrative space with abstraction ladder 800 and/or with abstraction tool tip 500 in FIG. 5. Additionally, or alternatively, in some embodiments, the boundary of the narrative space can be expanded or contracted by deleting one or more narrative instances associated with the narrative space. For example, a human co-author may delete a specific narrative instance that has an undesirably high emergence distance and/or an authorial intent distance indicated in variant view 600. One embodiment of a narrative space that is modified in this way is described below in conjunction with FIG. 9.

FIG. 9 conceptually illustrates a narrative space 900 that has a contracted boundary due to removal of a narrative instance from narrative space 900, according to various embodiments. Consistent with narrative space 400 in FIG. 4, narrative space 900 is an abstract representation of all the possible story lines associated with a narrative outline that a player can experience at play time, where the narrative outline is based on a representative narrative instance, such as an uploaded text-based story. As shown, narrative space 900 includes a pivot plot 901, a plurality of original narrative instances 902, an original narrative boundary 903 (dashed line), and a contracted narrative boundary 913 (solid line). Pivot plot 901 is a representative narrative instance for narrative space 900, and original narrative instances 902 are narrative instances that are generated based on an original narrative outline that is conceptually depicted as original narrative boundary 903. Contracted narrative boundary 913 corresponds to the smaller narrative space that results when narrative space 900 is modified by the removal of a deleted narrative instance 912. For example, when a human co-author removes deleted narrative instance 912 from narrative space 900, there are fewer remaining narrative instances, as shown.

### Narrative Space Generation for AI-bridged Interactive Storytelling

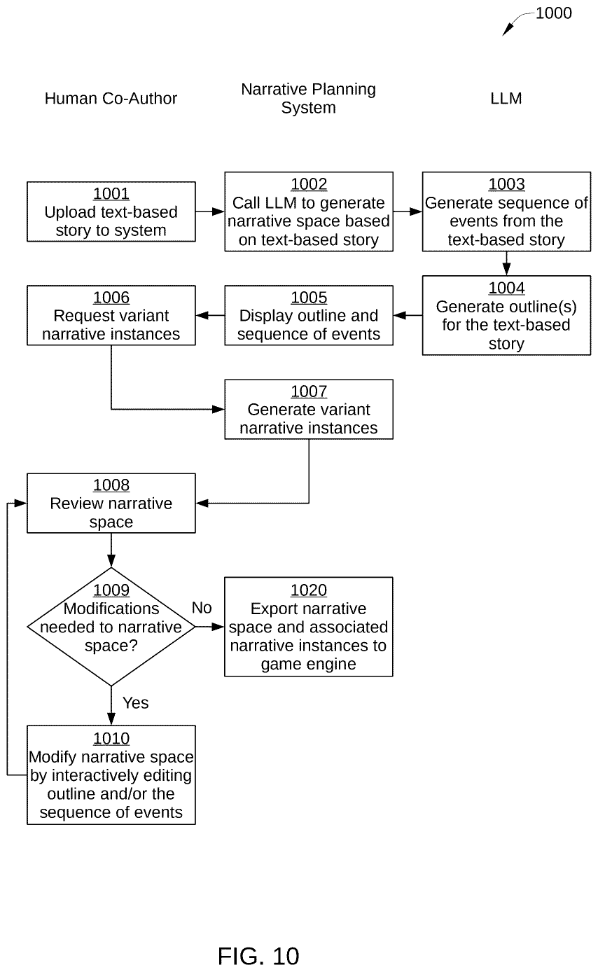

FIG. 10 sets forth a flowchart of method steps for generating narrative spaces for interactive storytelling, according to various embodiments. Although the method steps are described in conjunction with the system of FIGS. 1-9, persons skilled in the art will understand that any suitable system configured to perform the method steps, in any order, is within the scope of the embodiments.

A computer-implemented method 1000 begins at step 1001, where a text-based story or narrative is uploaded to narrative planning system 100, by a human co-author. For example, the text-based system can be uploaded as an input 102 via UI 110. In some embodiments, an explicit author-intended moral is also uploaded in step 1001 to narrative planning system 100.

In step 1002, narrative planning system 100 calls an LLM to generate a narrative space that is based on the text-based story uploaded in step 1001. For example, in some embodiments, narrative planning system 100 employs outline generator 121 to generate the narrative space.

In step 1003, the LLM generates a sequence of events (e.g., series of events 211-216) from the text-based story. In step 1004, the LLM generates a narrative outline (e.g., narrative outline 310) or a set of narrative outlines for the text-based story based on the sequence of events extracted from the text-based story. In some embodiments, the LLM generates one narrative outline for each level of abstraction available to outline generator 121. For example, in some embodiments, based on the sequence of events, outline generator 121 generates a narrative outline at the “beat” level of abstraction, a narrative outline at the “scene” level of abstraction, a narrative outline at the “sequence” level of abstraction, a narrative outline at the “act” level of abstraction, and a narrative outline at the “story” level of abstraction.

In step 1005, narrative planning system 100 displays the series of events as a pivot plot or representative narrative instance. For example, GUI 110 displays pivot plot view 200 depicting events 211-216. In some embodiments, narrative planning system 100 also displays a narrative outline of the text-based story associated with a requested abstraction level. Alternatively, in some embodiments, narrative planning system 100 displays a narrative outline at a requested abstraction level when the human co-author requests the display or generation of a narrative outline.

In step 1006, the human co-author requests narrative planning system 100 to generate one or more variant narrative instances. In step 1007, narrative planning system 100 generates a requested number of variant narrative instances based on the narrative outline, for example using narrative instance generator 122.

In step 1008, the human co-author reviews the narrative space, which is represented by the series of steps making up the pivot plot, the narrative outline generated by narrative planning system 100, and the variant narrative instances generated by narrative planning system 100. In some embodiments, the review in step 1008 includes requesting that narrative instance reviewer 123 quantify the performance of some or all variant narrative instances, for example by simulating the behavior of various player characters in the intended game environment. In such embodiments, the human co-author can then determine narrative instances that have an undesirably high emergence distance and/or an authorial intent distance. In some embodiments, the review in step 1008 includes reading the text of some or all of the variant narrative instances of the narrative space, for example to determine whether a variant narrative instance can include more abstract or more concrete language. In some embodiments, the review in step 1008 includes reading the text of some or all of the narrative outline of the narrative space, for example to determine whether the narrative outline instance include more abstract or more concrete language. In such embodiments, the human co-author can prompt narrative planning system 100 for suggested language and/or view a more or less abstract version of the narrative outline.

In step 1009, the human co-author determines whether any modifications are needed to the narrative space. For example, variant view 600 of the narrative space can quantify how closely variant narrative instances follow authorial intent. If modifications are needed, computer-implemented process 1000 proceeds to step 1010; if no modifications are needed, computer-implemented process 1000 proceeds to step 1020.

In step 1010, the human co-author modifies the narrative space by interactively editing the narrative outline and/or the variant narrative instances of the narrative space via narrative planning system 100. As noted above, such modifications can include requesting that narrative planning system 100 generate new or additional variant narrative instances, change an abstraction level of the narrative outline, delete one or more variant narrative instances, and/or modify the abstractness of selected language within a variant narrative instance or within the narrative outline. Computer-implemented process 1000 then returns to step 1008, where the human co-author can again review the narrative space.

In step 1020, narrative planning system 100 exports the narrative space and associated narrative instances to a suitable game engine.

### Exemplary Computing Device

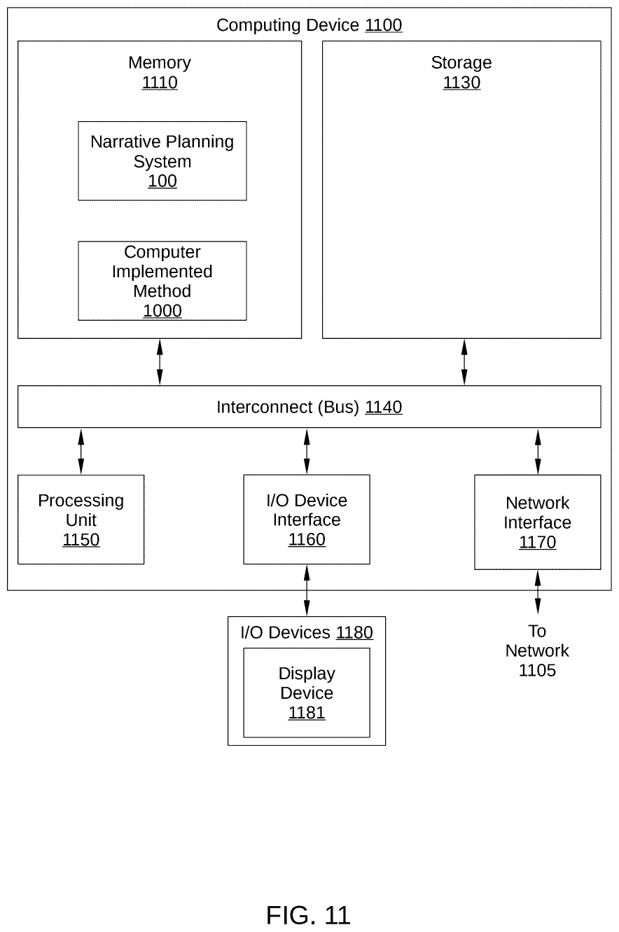

FIG. 11 is a block diagram of a computing device 1100 configured to implement one or more aspects of the various embodiments. Computing device 1100 may be a desktop computer, a laptop computer, a tablet computer, or any other type of computing device configured to receive input, process data, generate control signals, and display images. Computing device 1100 is configured to perform operations associated with transient atmosphere generation system 100, computer-implemented method 1000, and/or other suitable software applications, which can reside in a memory 1110. It is noted that the computing device described herein is illustrative and that any other technically feasible configurations fall within the scope of the present disclosure.

As shown, computing device 1100 includes, without limitation, an interconnect (bus) 1140 that connects a processing unit 1150, an input/output (I/O) device interface 1160 coupled to input/output (I/O) devices 1180, memory 1110, a storage 1130, and a network interface 1170. Processing unit 1150 may be any suitable processor implemented as a central processing unit (CPU), a graphics processing unit (GPU), an application-specific integrated circuit (ASIC), a field-programmable gate array (FPGA), any other type of processing unit, or a combination of different processing units, such as a CPU configured to operate in conjunction with a GPU. In general, processing unit 1150 may be any technically feasible hardware unit capable of processing data and/or executing software applications, including processes associated with narrative planning system 100 and/or computer-implemented method 1000. Further, in the context of this disclosure, the computing elements shown in computing device 1100 may correspond to a physical computing system (e.g., a system in a data center) or may be a virtual computing instance executing within a computing cloud.

I/O devices 1180 may include devices capable of providing input, such as a keyboard, a mouse, a touch-sensitive screen, and so forth, as well as devices capable of providing output, such as a display device 1181. Additionally, I/O devices 1180 may include devices capable of both receiving input and providing output, such as a touchscreen, a universal serial bus (USB) port, and so forth. I/O devices 1180 may be configured to receive various types of input from an end-user of computing device 1100, and to also provide various types of output to the end-user of computing device 1100, such as one or more graphical user interfaces (GUI), displayed digital images, and/or digital videos. In some embodiments, one or more of I/O devices 1180 are configured to couple computing device 1100 to a network 1105.

Memory 1110 may include a random access memory (RAM) module, a flash memory unit, or any other type of memory unit or combination thereof. Processing unit 1150, I/O device interface 1160, and network interface 1170 are configured to read data from and write data to memory 1110. Memory 1110 includes various software programs that can be executed by processor 1150 and application data associated with said software programs, including narrative planning system 100 and/or computer-implemented method 1000.

In sum, the various embodiments described herein provide an AI-based narrative planning system that generates narrative spaces for interactive storytelling. The narrative planning system is configured to author a narrative space from one or more example stories. The narrative space generally includes a plurality of possible interactive narratives. Interactive editing is facilitated with linguistic abstraction tools that control the boundaries of the narrative space. A narrative instance reviewer quantifies the performance of suggested narrative instances by simulating the behavior of a player character in an intended game environment.

At least one technical advantage of the disclosed techniques relative to the prior art is that the disclosed techniques enable a human co-author of an interactive narrative to clearly perceive the boundaries of the narrative space of the interactive narrative. Therefore, without performing extensive play testing, a human co-author can detect and eliminate narrative instances that diverge from the narrative intent of the human co-author. Another technical advantage is that a human co-author can control the boundaries of the narrative space by directly configuring the level of abstraction of words or sentences in the outline that defines the narrative space. As a result, the human co-author can prevent narrative instances generated at play time from being too similar to each other without deviating too far from the narrative intent of the human co-author. These technical advantages provide one or more technological advancements over prior art approaches.

1. In some embodiments, a computer-implemented method for generating narrative spaces for interactive storytelling includes: receiving a text-based story; generating, via a generative artificial intelligence (AI) model, a narrative outline based on the text-based story; generating, via the generative AI model, one or more narrative instances based on the narrative outline; simulating a performance of each of the one or more narrative instances; and displaying, via at least one user interface, a visual representation of the performance of each of the one or more narrative instances.

2. The computer-implemented method of clause 1, wherein simulating the performance of each of the one or more narrative instances comprises selecting a player character type from a set of available player character types.

3. The computer-implemented method of clauses 1 or 2, wherein the visual representation of the narrative space includes a presentation of the narrative outline.

4. The computer-implemented method of any of clauses 1-3, further comprising removing one of the one or more narrative instances from the narrative space in response to a user input.

5. The computer-implemented method of any of clauses 1-4, wherein the visual representation of the performance of each narrative instance of the one or more narrative instances includes a graph that quantifies the performance of each of the one or more narrative instances with respect to a pivot plot based on the text-based story.

6. The computer-implemented method of any of clauses 1-5, wherein the performance of each narrative instance of the one or more narrative instances includes a measure of an amount by which a sequence of events that occurs in a simulated emergent narrative diverges from an intended authorial plot sequence.

7. The computer-implemented method of any of clauses 1-6, wherein the performance of each narrative instance of the one or more narrative instances includes a measure of an amount by which a moral expressed by the narrative instance differs from a moral associated with the text-based story.

8. The computer-implemented method of any of clauses 1-7, further comprising displaying, via at least one user interface, a visual representation of a narrative space that includes the one or more narrative instances.

9. The computer-implemented method of any of clauses 1-8, wherein the narrative space includes a series of events extracted from the text-based story.

10. The computer-implemented method of any of clauses 1-9, wherein the visual representation of the narrative space includes a presentation of a series of events extracted from the text-based story.

11. In some embodiments, a non-transitory computer readable medium includes a set of instructions that, when executed by a processor of a computer system, cause the processor to perform the steps of: receiving a text-based story; generating, via a generative artificial intelligence (AI) model, a narrative outline based on the text-based story; generating, via the generative AI model, one or more narrative instances based on the narrative outline; simulating a performance of each of the one or more narrative instances; and displaying, via at least one user interface, a visual representation of the performance of each of the one or more narrative instances.

12. The non-transitory computer readable medium of clause 11, further comprising displaying, via at least one user interface, a visual representation of a narrative space that includes the one or more narrative instances.

13. The non-transitory computer readable medium of clauses 11 or 12, wherein the visual representation of the narrative space includes a presentation of the narrative outline.

14. The non-transitory computer readable medium of any of clauses 11-13, further comprising instructions that, when executed by the processor of the computer system, cause the processor to perform the step of removing one of the one or more narrative instances from the narrative space in response to a user input.

15. The non-transitory computer readable medium of any of clauses 11-14, wherein the narrative space includes a series of events extracted from the text-based story.

16. The non-transitory computer readable medium of any of clauses 11-15, wherein the series of events corresponds to a pivot plot of the narrative space.

17. The non-transitory computer readable medium of any of clauses 11-16, further comprising generating the narrative outline with the generative AI model by summarizing a series of events extracted from the text-based story.

18. The non-transitory computer readable medium of any of clauses 11-17, further comprising instructions that, when executed by the processor of the computer system, cause the processor to perform the step of generating, using the generative AI model, a modified narrative outline, wherein the modified narrative outline has a different abstraction level than the narrative outline based on the text-based story.

19. The non-transitory computer readable medium of any of clauses 11-18, wherein the visual representation of the performance of each narrative instance of the one or more narrative instances includes a graph that quantifies the performance of each of the one or more narrative instances with respect to a pivot plot based on the text-based story.

20. In some embodiments, a system comprises: a memory that stores instructions; and a processor that is communicatively coupled to the memory and is configured to, when executing the instructions, perform the steps of: receiving a text-based story; generating, via a generative artificial intelligence (AI) model, a narrative outline based on the text-based story; generating, via the generative AI model, one or more narrative instances based on the narrative outline; simulating a performance of each of the one or more narrative instances; and displaying, via at least one user interface, a visual representation of the performance of each of the one or more narrative instances.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating narrative spaces for interactive storytelling, the method comprising:
receiving a text-based story;
generating, via a generative artificial intelligence (AI) model, a narrative outline based on the text-based story;
generating, via the generative AI model, one or more narrative instances based on the narrative outline;
simulating a performance of each of the one or more narrative instances; and
displaying, via at least one user interface, a visual representation of the performance of each of the one or more narrative instances.

2. The computer-implemented method of claim 1, wherein simulating the performance of each of the one or more narrative instances comprises selecting a player character type from a set of available player character types.

3. The computer-implemented method of claim 2, wherein the visual representation of the narrative space includes a presentation of the narrative outline.

4. The computer-implemented method of claim 2, further comprising removing one of the one or more narrative instances from the narrative space in response to a user input.

5. The computer-implemented method of claim 1, wherein the visual representation of the performance of each narrative instance of the one or more narrative instances includes a graph that quantifies the performance of each of the one or more narrative instances with respect to a pivot plot based on the text-based story.

6. The computer-implemented method of claim 5, wherein the performance of each narrative instance of the one or more narrative instances includes a measure of an amount by which a sequence of events that occurs in a simulated emergent narrative diverges from an intended authorial plot sequence.

7. The computer-implemented method of claim 5, wherein the performance of each narrative instance of the one or more narrative instances includes a measure of an amount by which a moral expressed by the narrative instance differs from a moral associated with the text-based story.

8. The computer-implemented method of claim 1, further comprising displaying, via at least one user interface, a visual representation of a narrative space that includes the one or more narrative instances.

9. The computer-implemented method of claim 8, wherein the narrative space includes a series of events extracted from the text-based story.

10. The computer-implemented method of claim 8, wherein the visual representation of the narrative space includes a presentation of a series of events extracted from the text-based story.

11. A non-transitory computer readable medium that includes a set of instructions that, when executed by a processor of a computer system, cause the processor to perform the steps of:
receiving a text-based story;
generating, via a generative artificial intelligence (AI) model, a narrative outline based on the text-based story;
generating, via the generative AI model, one or more narrative instances based on the narrative outline;
simulating a performance of each of the one or more narrative instances; and
displaying, via at least one user interface, a visual representation of the performance of each of the one or more narrative instances.

12. The non-transitory computer readable medium of claim 11, further comprising displaying, via at least one user interface, a visual representation of a narrative space that includes the one or more narrative instances.

13. The non-transitory computer readable medium of claim 11, wherein the visual representation of the narrative space includes a presentation of the narrative outline.

14. The non-transitory computer readable medium of claim 13, further comprising instructions that, when executed by the processor of the computer system, cause the processor to perform the step of removing one of the one or more narrative instances from the narrative space in response to a user input.

15. The non-transitory computer readable medium of claim 11, wherein the narrative space includes a series of events extracted from the text-based story.

16. The non-transitory computer readable medium of claim 15, wherein the series of events corresponds to a pivot plot of the narrative space.

17. The non-transitory computer readable medium of claim 11, further comprising generating the narrative outline with the generative AI model by summarizing a series of events extracted from the text-based story.

18. The non-transitory computer readable medium of claim 11, further comprising instructions that, when executed by the processor of the computer system, cause the processor to perform the step of generating, using the generative AI model, a modified narrative outline, wherein the modified narrative outline has a different abstraction level than the narrative outline based on the text-based story.

19. The non-transitory computer readable medium of claim 11, wherein the visual representation of the performance of each narrative instance of the one or more narrative instances includes a graph that quantifies the performance of each of the one or more narrative instances with respect to a pivot plot based on the text-based story.

20. A system, comprising:
a memory that stores instructions; and
a processor that is communicatively coupled to the memory and is configured to, when executing the instructions, perform the steps of:
receiving a text-based story;
generating, via a generative artificial intelligence (AI) model, a narrative outline based on the text-based story;
generating, via the generative AI model, one or more narrative instances based on the narrative outline;
simulating a performance of each of the one or more narrative instances; and
displaying, via at least one user interface, a visual representation of the performance of each of the one or more narrative instances.
